(19) United States
(12) Patent Application Publication
(10) Pub. No.: US 2017/0155236 A1
(43) Pub. Date: Jun. 1, 2017

(54) UTILITY SUPPORT APPARATUS

(71) Applicant: ALPHASTRUT LTD, Edinburgh Lothian (GB)

(72) Inventor: Andrew MUNRO, Auchterarder (UK)

(21) Appl. No.: 15/326,001

(22) PCT Filed: Jul. 15, 2015
(86) PCT No.: PCT/GB2015/052050

§ 371 Date: Jan. 12, 2017

(30) Foreign Application Priority Data
Jul. 15, 2014 (GB) 1412571.0

(51) Int. Cl. H02G 3/04; H02G 3/00; F16M 13/02; H02G 3/38

(52) U.S. Cl. CPC H02G 3/0456; H02G 3/381; H02G 3/263; F16M 13/027

(57) ABSTRACT

The present invention relates to utility support apparatus (30). The utility support apparatus (30) comprises first (32) and second (34) elongate arrangements each configured towards a proximal end to be attached to a structure so as to depend from the structure. The utility support apparatus (30) also comprises a holding arrangement configured to, in use, hold utility distribution elements. The first and second elongate arrangements (32, 34) are mechanically coupled to the holding arrangement at spaced apart locations on the holding arrangement. Each of the first and second elongate arrangements (32, 34) is mechanically coupled to the holding arrangement at a location on the elongate arrangement spaced apart from the proximal end. Each of the first and second elongate arrangements (32, 34) comprises a first aperture (42) towards the proximal end to provide for attachment to the structure and second and third apertures (44, 46) spaced apart from the proximal end, the second and third apertures (44, 46) providing for mechanical coupling to the holding arrangement. The first, second and third apertures (42, 44, 46) lie in the same plane.

### FIELD OF THE INVENTION

The present invention relates to utility support apparatus for supporting utility distribution elements such as cables or ducts. The present invention also relates to an elongate structural member configured to form part of a modular structure and in particular but not exclusively to form part of utility support apparatus.

### BACKGROUND ART

It is known to support utility distribution elements, such as cables or ducts, within buildings and other constructions by way of utility support apparatus. The utility support apparatus typically comprises a tray which carries the utility distribution elements with the utility support apparatus being attached to a soffit such that the tray is suspended from the soffit. Where aesthetics are of concern, the utility support apparatus is enclosed between the soffit and a false ceiling.

The present inventor has become appreciative of shortcomings of known utility support apparatus. The present invention has been devised in the light of the inventor's appreciation of such shortcomings. It is therefore an object for the present invention to provide improved utility support apparatus for supporting utility distribution elements such as cables or ducts. It is a further object for the present invention to provide improved utility support apparatus which is configured to be suspended from a structure such as a soffit in a construction.

### STATEMENT OF INVENTION

According to a first aspect of the present invention there is provided utility support apparatus comprising:
first and second elongate arrangements each configured towards a proximal end to be attached to a structure so as to depend from the structure; and
a holding arrangement configured to, in use, hold utility distribution elements,
the first and second elongate arrangements being mechanically coupled to the holding arrangement at spaced apart locations on the holding arrangement, each of the first and second elongate arrangements being mechanically coupled to the holding arrangement at a location on the elongate arrangement spaced apart from the proximal end, in which
each of the first and second elongate arrangements comprises a first aperture towards the proximal end to provide for attachment to the structure and second and third apertures spaced apart from the proximal end, the second and third apertures providing for mechanical coupling to the holding arrangement and the first, second and third apertures lying in the same plane.

The utility support apparatus comprises first and second elongate arrangements and a holding arrangement. The first and second elongate arrangements are each configured towards a proximal end to be attached to a structure, such as a soffit, so as to depend from the structure. The holding arrangement may be configured to, in use, hold utility distribution elements such as cables or ducts. The first and second elongate arrangements are mechanically coupled to the holding arrangement at spaced apart locations on the holding arrangement, for example at or towards opposite sides of the holding arrangement. Also each of the first and second elongate arrangements is mechanically coupled to the holding arrangement at a location on the elongate arrangement spaced apart from the proximal end. The holding arrangement may thus, when in use, be suspended by way of the first and second elongate arrangements from the structure. The utility support apparatus may therefore be suspended utility support apparatus. Each of the first and second elongate arrangements comprises a first aperture towards the proximal end to provide for attachment to the structure. Each of the first and second elongate arrangements also comprises second and third apertures spaced apart from the proximal end, with the second and third apertures providing for mechanical coupling to the holding arrangement. The first, second and third apertures lie substantially in the same plane. The second and third apertures may therefore be spaced apart from the first aperture along the elongate arrangement. Such a configuration may provide for ease of construction of utility support apparatus compared with known utility support apparatus.

The second and third apertures may lie across the elongate arrangement. The second and third apertures may therefore lie on a line which extends substantially orthogonally to a longitudinal axis of the elongate arrangement. The centres of the second and third apertures may be substantially equally spaced from a longitudinal axis of the elongate arrangement. A longitudinal axis of the elongate arrangement may be a line which bisects the elongate arrangement and more specifically which bisects the plane in which the first, second and third apertures lie. The second and third apertures may be defined towards respective opposite sides of the elongate arrangement. The second and third apertures may be of substantially the same shape and perhaps also substantially the same dimensions. More specifically the second and third apertures may be substantially circular.

The first aperture may lie on a longitudinal axis of the elongate arrangement. More specifically the first aperture may be bisected by the longitudinal axis. The first aperture may be substantially circular. The first aperture may be larger than each of the second and third apertures. A diameter of the first aperture may be at least twice a diameter of each of the second and third apertures.

Each of the first and second elongate arrangements may comprise plural pairs of second and third apertures, the pairs of second and third apertures being spaced apart along the elongate arrangement and perhaps spaced apart substantially equally along the elongate arrangement. The plural pairs of second and third apertures may extend between the proximal and distal ends of the elongate arrangement. The provision of plural pairs of second and third apertures spaced apart along the elongate arrangements may allow, for example, for the mechanical coupling of the holding arrangement at one of different locations along the elongate arrangements such that the holding arrangement is suspended at a selected height. By way of further example the provision of plural pairs of second and third apertures spaced apart along the elongate arrangements may allow for mechanical coupling to plural holding arrangements at different locations at the same time whereby the plural holding arrangements are suspended above one another.

Each of the first and second elongate arrangements may comprise plural first apertures, the first apertures being spaced apart along the elongate arrangement and perhaps spaced apart substantially equally along the elongate arrangement. The provision of plural first apertures spaced apart along the elongate arrangement may allow, for example, for the elongate arrangement to be attached to the structure at plural locations at the same time, such as by way of a bracket which extends down from the structure or to plural struts, of a form described below, which extend in parallel along the holding arrangement. By way of another example the provision of plural first apertures spaced apart along the elongate arrangement may allow for the elongate arrangement to be cut to a desired length. Elongate arrangements may therefore be provided in a standard length and then cut to a desired length depending on a desired height of suspension of the holding arrangement. The plural first apertures may extend between the proximal and distal ends of the elongate arrangement. Where an elongate arrangement comprises plural pairs of second and third apertures, at least one of the first apertures may be between and perhaps equally spaced between two spaced apart pairs of second and third apertures. A distance between a centre of the first aperture and a centre of each of the second and third apertures of each of two adjacent pairs of second and third apertures may be therefore substantially the same.

The first aperture may be configured to receive a fixing member, such as a bolt. The bolt may be further received in another component such as a strut comprised in the structure from which the elongate arrangement depends. The strut may extend in a same direction as the holding arrangement such that the strut extends in a direction of utility distribution elements held by the holding arrangement. The strut may be comprised in a structure and perhaps a modular structure configured to form part of a construction as described further below.

The first and second elongate arrangements and the holding arrangement may be formed separately from each other. The first and second elongate arrangements and the holding arrangement may constitute separate components. The utility support apparatus may be modular utility support apparatus comprising components which are connectable in each of plural different ways to form differently configured utility support apparatus. Each of the first and second elongate arrangements may releasably mechanically couple to the holding arrangement. An elongate arrangement may be mechanically coupled to the holding arrangement by way of a fixing member, such as a bolt or screw, which is received in each of the second and third apertures and mechanically couples with the holding arrangement to thereby support the holding arrangement from the elongate arrangements.

At least one of the first and second elongate arrangements may comprise an elongate planar member which defines the first to third apertures. In a first embodiment the elongate arrangement may consist essentially of the elongate planar member. In a second embodiment the elongate arrangement may comprise the elongate planar member and at least one further elongate planar member, the elongate planar member, i.e. first elongate planar member, and the further elongate planar member, i.e. second elongate planar member, extending in planes which are orthogonal to each other. The second elongate planar member may extend from each of two oppositely directed faces of the first elongate planar member. The elongate arrangement may comprise the first elongate planar member and two second elongate planar members, the two second elongate planar members extending from opposite sides of the first elongate planar member. An elongate arrangement according to the second embodiment may be unitarily formed. An elongate arrangement according to the second embodiment may provide for greater longitudinal rigidity whereby the utility support apparatus may be more stable, for example, in an offshore environment where the utility support apparatus may be subject to greater forces than in a land based environment.

The holding arrangement may be elongate such that it extends, for example, for several and perhaps many meters. A holding arrangement may therefore be supported by plural pairs of first and second elongate arrangements, the pairs of first and second elongate arrangements being mechanically coupled to the holding arrangement at spaced apart locations along the holding arrangement.

The holding arrangement may be configured to define an open ended space. In use, utility distribution elements may be received in the open ended space. The opening may be directed such that, in use, it faces towards the structure to which the first and second elongate arrangements are attached at or towards their proximal ends. The holding arrangement may therefore comprise a tray, such as a cable tray. The tray may define a mesh structure formed, for example, from elongate lengths of metal wire.

The utility support apparatus may further comprise at least one cross member. The cross member may be disposed such that it supports the holding arrangement. More specifically the holding arrangement may bear against the cross member whereby the cross member supports the weight of the holding arrangement. Where the holding arrangement comprises a tray, the cross member may be disposed such that it supports the tray and thereby, in use, bears the weight of the tray and utility distribution elements held in the tray. Each of the first and second elongate arrangements may be attached to the cross member at spaced apart locations on the cross member. More specifically an elongate arrangement may be attached at an end of the cross member. The cross member may define two spaced apart recesses. The recesses may be spaced apart across an end face of the cross member. Each recess may be configured to receive a fixing member, such as a bolt or screw, which is received through a respective one of the second and third apertures. The two recesses defined by the cross member may therefore be separated by substantially a same distance as a distance separating the second and third apertures.

The utility support apparatus may comprise plural spaced apart cross members. The plural cross members may be spaced apart along the holding arrangement. Each of the plural cross members may be attached to a different pair of first and second elongate arrangements.

The cross member may define a channel. The cross member may comprise a base member and two spaced apart arms which extend from the base member to define the channel therebetween. The two arms may extend from opposite sides of the base member. Such a structure may provide for rigidity whilst saving on material used to form the cross member. Where the cross member defines two spaced apart recesses, the recesses may be defined in the base member. The cross member may comprise two further spaced apart arms. The two further spaced apart arms may extend from an oppositely directed face of the base member to the two spaced apart arms to thereby define a second channel between the two further spaced apart arms. Openings to the first and second channels may be thus substantially oppositely directed.

The base member may define at least one bore. The bore may extend from one end of the cross member to the other end along its length. The at least one bore is a recess apart from the two spaced apart recesses for receiving the fixing members described above. The provision of at least one bore may save upon material used to form the cross member without compromising on structural integrity. The bore may extend through the centre of the base member. The bore may extend through the base member half way between opposite sides of the cross member. Such a bore may provide for ease of driving of a screw from the channel through the base member by providing a thinner section of base member between the channel and the bore. The base member may define plural bores. The plural bores may each extend from one end of the cross member to the other end along its length. The plural bores may be spaced apart across the base member. More specifically longitudinal axes of the plural bores may be spaced apart across the base member and may be substantially parallel to each other. A cross section through the plural bores may lie in a plane which is orthogonal to a longitudinal axis of the cross member. A bore may be defined towards a side of the base member, such as near where an arm extends from the base member. A bore may be in fluid communication with a recess for receiving a fixing member. The base member may define a passage between the bore and the recess, the passage being narrower than the bore and the recess. Having a passage between the bore and the recess may make it easier to drive a screw into the recess by allowing for expansion of the recess by allowing for material that defines the recess to be forced into the bore.

The utility support apparatus may be formed substantially of metal. The first and second elongate arrangements may be formed of aluminium. Each of the first and second elongate arrangements may be integrally formed. Each of the first and second elongate arrangements may be formed by cutting from a single piece of metal, such as by laser or water cutting. Where the holding arrangement comprises a cross member, the cross member may be formed of aluminium. The cross member may be integrally formed, such as by extrusion. Where the holding arrangement comprises a tray, the tray may be formed of stainless steel.

Each of the first and second elongate arrangements may be less than 80 mm, 70 mm, 60 mm, 50 mm or 45 mm wide. In a form, each of the first and second elongate arrangements may be 42 mm wide. The first aperture may have a diameter of less than 25 mm, 20 mm or 15 mm. The first aperture may have a diameter of more than 5 mm or 10 mm. In a form, the first aperture may have a diameter of 14 mm. Each of the second and third apertures may have a diameter of less than 20 mm, 15 mm or 10 mm. Each of the second and third apertures may have a diameter of more than 2 mm or 4 mm. In a form, each of the second and third apertures may have a diameter of 6 mm. The cross member may be less than 80 mm, 70 mm, 60 mm, 50 mm or 45 mm wide. In a form, the cross member may be 42 mm wide. The cross member may be less than 80 mm, 70 mm, 60 mm, 50 mm or 40 mm deep.

According to a second aspect of the present invention there is provided a kit of parts which when assembled forms utility support apparatus according to the first aspect of the present invention. Embodiments of the second aspect of the present invention may comprise one or more features of the first aspect of the present invention.

As mentioned above, the utility support apparatus is configured to depend from a structure. The structure may be a soffit comprised in a building or other construction. The soffit may be comprised in an overhead structure, such as a ceiling. Alternatively the soffit may be comprised in a floor structure and more specifically an under floor structure. The utility support apparatus may therefore be suspended underneath a floor structure.

According to a third aspect of the present invention there is provided a structure configured to form part of a construction, such as a building or an offshore oil or gas exploration or recovery facility, the structure comprising utility support apparatus according to the first aspect of the present invention. The structure may be configured to form at least part of an overhead structure. Alternatively the structure may be configured to form at least part of a floor structure. The structure may, in common with the utility support apparatus, be of modular form. Further embodiments of the third aspect of the present invention may comprise one or more features of the first aspect of the present invention and vice-versa.

The present inventor has appreciated the features of the cross member to be of wider applicability than hitherto described. Therefore and according to a fourth aspect of the present invention there is provided an elongate structural member configured to form part of a modular structure, such as utility support apparatus, in a construction such as a building, the elongate structural member comprising:
a base member;
two spaced apart arms which extend from the base member to define a channel therebetween,
the base member defining at least one recess which extends from an end of the elongate structural member along the elongate structural member and which is configured to receive and engage with a fixing member, the base member further defining a bore which extends along the elongate structural member and is located beneath the channel.

The elongate structural member may be brought into use by forming the like of utility support apparatus in which the elongate structural member constitutes a cross member. The at least one recess defined in the base member of the elongate structural member provides for attachment of the elongate structural member to another component of the modular structure by way of a fixing member, such as a bolt or screw, which is received in and engages with the recess. The base member further defines a bore which extends along the elongate structural member and is located beneath the channel. The bore may not only provide for saving of material used to form the elongate structural member but may also allow for ease of driving of a fixing member, such as a screw, from the channel into the base member on account of there being a thinner section of material between the channel and the bore. Such a fixing member may be driven from the channel into the base member to fix another component of the modular structure, such as a cable tray, to the elongate structural member.

Further embodiments of the fourth aspect of the present invention may comprise one or more features of the first aspect of the present invention.

According to a fifth aspect of the present invention there is provided utility support apparatus comprising:
first and second elongate arrangements each configured towards a proximal end to be attached to a structure so as to depend from the structure;
a cross member; and
a holding arrangement configured to, in use, hold utility distribution elements, the holding arrangement being supported by the cross member,
the first and second elongate arrangements being attached to the cross member at spaced apart locations on the cross member, each of the first and second elongate arrangements being attached to the cross member at a location on the elongate arrangement spaced apart from the proximal end, in which
each of the first and second elongate arrangements comprises a first aperture towards the proximal end to provide for attachment to the structure and a second aperture spaced apart from the proximal end to provide for attachment to the cross member, the first and second apertures lying in the same plane, and
the cross member defines a bore in each end thereof, the bore being located substantially midway across the cross member, the bore being configured to engage with a fixing member received through the second aperture of an elongate arrangement.

The utility support apparatus comprises first and second elongate arrangements which are each configured towards a proximal end to be attached to a structure, such as a soffit, so as to depend from the structure. The utility support apparatus further comprises a cross member and a holding arrangement which is configured to, in use, hold utility distribution elements. The holding arrangement is supported by the cross member. Typically the utility support apparatus may comprise plural spaced apart pairs of first and second elongate arrangements and plural spaced apart cross members on which a holding arrangement, such as a cable tray, is supported. The first and second elongate arrangements are attached to the cross member at spaced apart locations on the cross member. Each of the first and second elongate arrangements is attached to the cross member at a location on the elongate arrangement spaced apart from the proximal end of the elongate arrangement. Each of the first and second elongate arrangements comprises a first aperture towards the proximal end to provide for attachment to the structure and a second aperture spaced apart from the proximal end to provide for attachment to the cross member. The first and second apertures lie in the same plane. The cross member defines a bore in each end thereof. The bore is located substantially midway across the cross member and is configured to engage with a fixing member, such as a screw or bolt, received through the second aperture of an elongate arrangement. The utility support apparatus may further comprise two fixing members, one for each end of the cross member. The elongate arrangement may be thus attached to the cross member at an end thereof.

The first and second apertures may be located substantially midway across the elongate arrangement. The elongate arrangement may define more than two apertures along its length, the first and second apertures being comprised in the more than two apertures. The more than two apertures may be substantially evenly spaced along the elongate arrangement. The more than two apertures may extend from towards the proximal end of the elongate arrangement towards the distal end of the elongate arrangement.

As mentioned above, the bore defined in each end of the cross member is configured to engage with a fixing member. More specifically the bore may be defined by an uneven surface. The uneven surface may be such that the fixing member, such as a threaded profile thereon, bites into the uneven surface to thereby provide for secure attachment of the fixing member to the cross member. The surface of the bore may define a plurality of ridges which extend into the bore. The plurality of ridges may be spaced apart substantially evenly around the bore. The bore in each end of the cross member may both be defined by a bore that extends through the cross member from end to end.

The cross member may define a channel. The cross member may comprise a base member and two spaced apart arms which extend from the base member to define the channel therebetween. The two arms may extend from opposite sides of the base member. Such a structure may provide for rigidity whilst saving on material used to form the cross member. The bore in each end of the cross member may be defined in the base member.

The base member may define at least one further bore. The further bore may extend from one end of the cross member to the other end along its length. The provision of at least one further bore may save upon material used to form the cross member without compromising on structural integrity. The further bore may be located closer to a side of the cross member than the bore for engaging with the fixing member. The further bore may be of noncircular cross section. Where the base member defines first and second further bores, the bore for engaging with the fixing member may be between the first and second further bores across the cross member.

The cross member may comprise two further spaced apart arms. The two further spaced apart arms may extend from an oppositely directed face of the base member to the two spaced apart arms to thereby define a second channel between the two further spaced apart arms. Openings to the first and second channels may be thus substantially oppositely directed.

Further embodiments of the fifth aspect of the present invention may comprise one or more features of any previous aspect of the present invention and vice-versa.

According to a sixth aspect of the present invention there is provided an elongate structural member configured to form part of a modular structure, such as utility support apparatus, in a construction such as a building, the elongate structural member comprising:
a base member;
two spaced apart arms which extend from the base member to define a channel therebetween,
the base member defining a bore in each end thereof, the bore being located substantially midway across the cross member, the bore having an uneven surface to provide for engagement with a fixing member.

The elongate structural member is configured to form part of a modular structure, such as utility support apparatus, in a construction such as a building. The elongate structural member comprises a base member and two spaced apart arms which extend from the base member to define a channel therebetween. The base member defines a bore in each end thereof. The bore is located substantially midway across the cross member and has an uneven surface to provide for engagement with a fixing member. The bore may be located in the base member in a direction midway across a width of the channel. In use, the fixing member, such as a screw or bolt, is received through an aperture formed in another component of the modular structure before being received in and engaging with the bore of the elongate structural member to thereby attach the cross member to the other component of the modular structure.

Further embodiments of the sixth aspect of the present invention may comprise one or more features of any previous aspect of the present invention and vice-versa.

According to a further aspect of the present invention there is provided utility support apparatus comprising: first and second elongate arrangements each configured towards a proximal end to be attached to a structure so as to depend from the structure; and a holding arrangement configured to, in use, hold utility distribution elements, the first and second elongate arrangements being mechanically coupled to the holding arrangement at spaced apart locations on the holding arrangement, each of the first and second elongate arrangements being mechanically coupled to the holding arrangement at a location on the elongate arrangement spaced apart from the proximal end, in which each of the first and second elongate arrangements comprises a first aperture towards the proximal end to provide for attachment to the structure and at least one further aperture spaced apart from the proximal end, the at least further aperture providing for mechanical coupling to the holding arrangement.

The at least one further aperture may comprise second and third apertures. The first, second and third apertures may lie in the same plane. Further embodiments of the further aspect of the present invention may comprise one or more features of any previous aspect of the present invention.

### BRIEF DESCRIPTION OF DRAWINGS

Further features and advantages of the present invention will become apparent from the following specific description, which is given by way of example only and with reference to the accompanying drawings, in which:

FIG. 1 shows a floor structure from which utility support apparatus according to the present invention is suspended;

FIG. 2A shows first and second elongate arrangements and a cross member of the utility support apparatus of FIG. 1 before assembly;

FIG. 2B shows the first and second elongate arrangements and the cross member of FIG. 2A when assembled;

FIG. 3A shows the connection of an elongate arrangement and a cross member;

FIG. 3B shows alternative forms of elongate arrangement;

FIGS. 4A and 4B show cross sections through the alternative forms of elongate arrangement;

FIGS. 5A, 5B and 5C show cross sections through alternative forms of cross member;

FIGS. 6A and 6B respectively show a cross section through and a perspective view of a further embodiment of cross member; and

FIGS. 7A and 7B respectively show a cross section through and a perspective view of a yet further embodiment of cross member.

### DESCRIPTION OF EMBODIMENTS

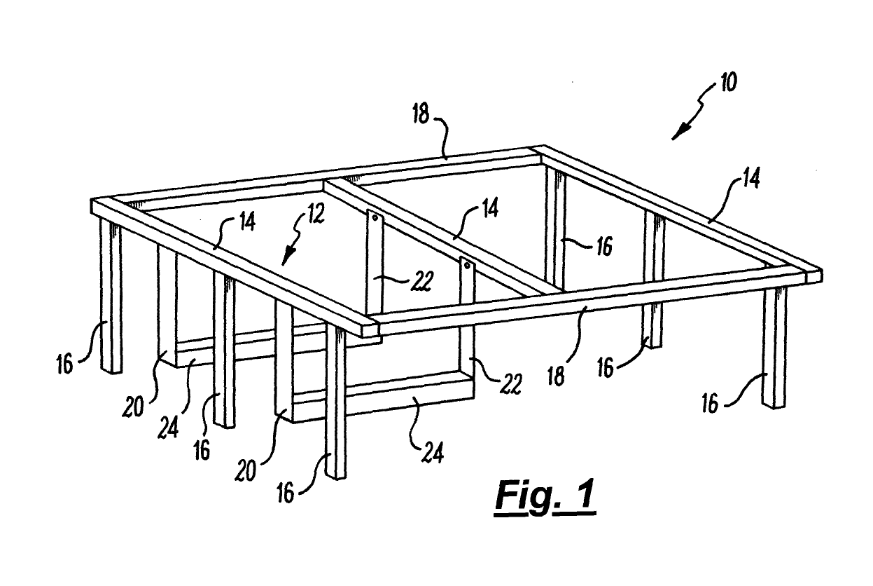

A floor structure 10 from which utility support apparatus 12 according to the present invention is suspended is shown in FIG. 1. The floor structure 10 comprises three parallel horizontal first struts 14 which extend from the front to the back of the floor structure. The horizontal first struts 14 are supported on legs 16 at spaced apart locations. Two horizontal second struts 18 extend from one side to another side of the floor structure 10. The two second struts 18 extend between opposite ends of the first struts 14 to define a box structure. Although not shown in FIG. 1 the floor structure 10 comprises decking which is laid over and attached to the first and second struts 14, 18 to form a raised floor. As can be seen from FIG. 1, the floor structure 10 defines a space underneath the box structure formed by the first and second struts 14, 18. Although the utility support apparatus 12 is shown in FIG. 1 as forming part of a floor structure the utility support apparatus 12 also forms part of other structures such as ceiling structures.

The utility support apparatus 12 comprises first and second pairs of elongate support arrangements. Each pair of elongate support arrangements comprises a first elongate support arrangement 20 and a second elongate support arrangement 22. The utility support apparatus 12 further comprises first and second cross members 24. The pairs of elongate support arrangements are spaced apart along the first struts 14. A first, proximal end of each elongate support arrangement 20, 22 is attached to a strut 14 by way of a bolt whereby the elongate support arrangements 20, 22 depend from the box structure formed by the first and second struts 14, 18.

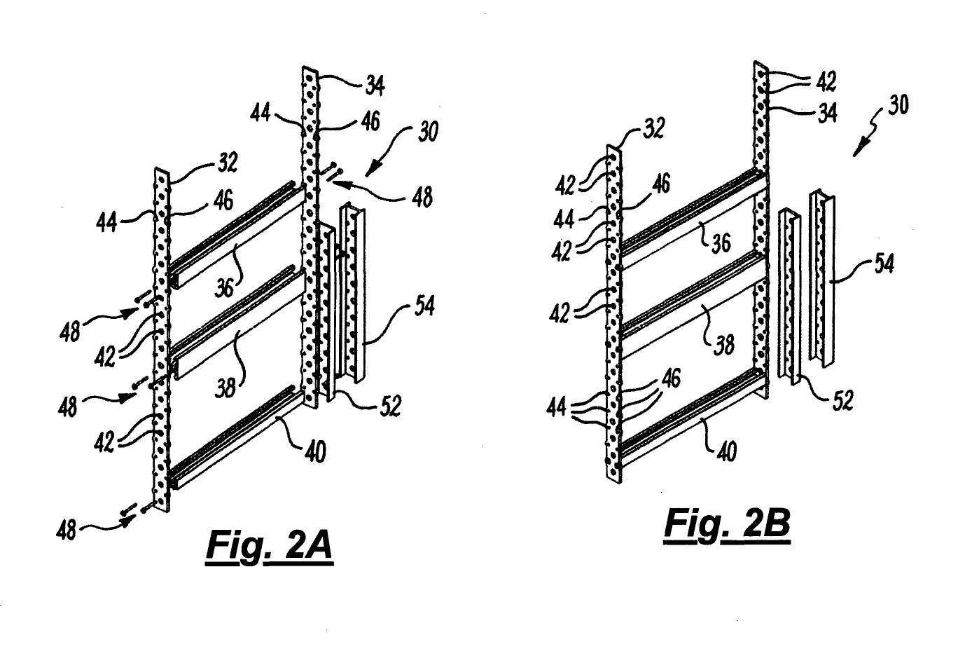

Attachment of the elongate support arrangements to a strut is described in more detail below with reference to FIGS. 2A and 2B. Each elongate support arrangement 20, 22 is attached at its distal end to an end of the cross member 24. More specifically each first elongate support arrangement 20 is attached to a first end of the cross member 24 and each second elongate support arrangement 22 is attached to a second opposite end of the cross member. A pair of elongate support arrangements and a cross member thus form a cradle. Although not shown in FIG. 1, the utility support apparatus 12 further comprises a cable tray of known form and function. The cable tray is placed so it is supported by the two spaced apart cradles formed by the elongate support arrangements and the cross members. In use, utility distribution elements such as electrical cables and ducts for conveying the like of water and gas are placed in the cable tray. The utility support apparatus 12 is therefore operative to support and contain the utility distribution elements in the space underneath the box structure formed by the first and second struts 14, 18. When the utility support apparatus 12 is suspended from an overhead structure, such as a ceiling, the upper ends of the elongate support arrangements are attached to struts in the overhead structure by way of bolts in the same fashion as described above for the floor structure. Otherwise an overhead structure suspended utility support apparatus 12 is operative to support a cable tray as described above.

First and second elongate arrangements and a cross member of the utility support apparatus of FIG. 1 are shown in FIG. 2A before assembly and in FIG. 2B when assembled. The utility support apparatus 30 of FIGS. 2A and 2B comprises a first elongate support arrangement 32 and a second elongate support arrangement 34. The utility support apparatus 30 further comprises a first cross member 36, a second cross member 38 and a third cross member 40. Each elongate support arrangement 32, 34 consists of a planar sheet of material. Each elongate support arrangement 32, 34 is 42 mm wide. As can be seen from FIGS. 2A and 2B, each elongate support arrangement 32, 34 defines plural first apertures 42 which are spaced apart equally along the elongate arrangement. Each first aperture 42 is substantially circular and is defined in the elongate support arrangement such that the first aperture is bisected by a longitudinal axis of the elongate arrangement. The first aperture has a diameter of 14 mm. An elongate support arrangement is attached to a first strut 14 of the structure of FIG. 1 by way of a bolt which is received in the first aperture 42 closest to the proximal end of the elongate support arrangement.

Each elongate support arrangement 32, 34 further defines plural pairs of a second aperture 44 and a third aperture 46 with the plural pairs of second and third apertures being spaced apart along the elongate support arrangement. The first to third apertures 42, 44, 46 lie in the plane defined by the elongate support arrangement. The second and third apertures 44, 46 are circular. Each of the second and third apertures 44, 46 has a diameter of 6 mm. The second apertures 44 are defined towards a first side of the elongate support arrangement and the third apertures 46 are defined towards a second, opposite side of the elongate support arrangement. The two opposite edges of the elongate support arrangement define plural spaced apart protrusions with each protrusion being proximate a second or third aperture whereby the second or third aperture can be defined closer to an edge of the elongate support arrangement without compromising the structural integrity of the elongate support arrangement. The centres of each second aperture 44 and third aperture 46 in a pair lie on a line which extends substantially orthogonally to a longitudinal axis of the elongate arrangement and such that the centres of the second and third apertures are substantially equally spaced from the longitudinal axis. Each first aperture 42 is equally spaced between adjacent pairs of second and third apertures 44, 46. A distance between a centre of a first aperture 42 and a centre of each of the second and third apertures 44, 46 of each of two adjacent pairs of second and third apertures is therefore substantially the same. Each elongate support arrangement 32, 34 is formed from a single sheet of aluminium by laser or water cutting. The apertures are formed at the same time by laser or water cutting. Each cross member is formed by extrusion of aluminium.

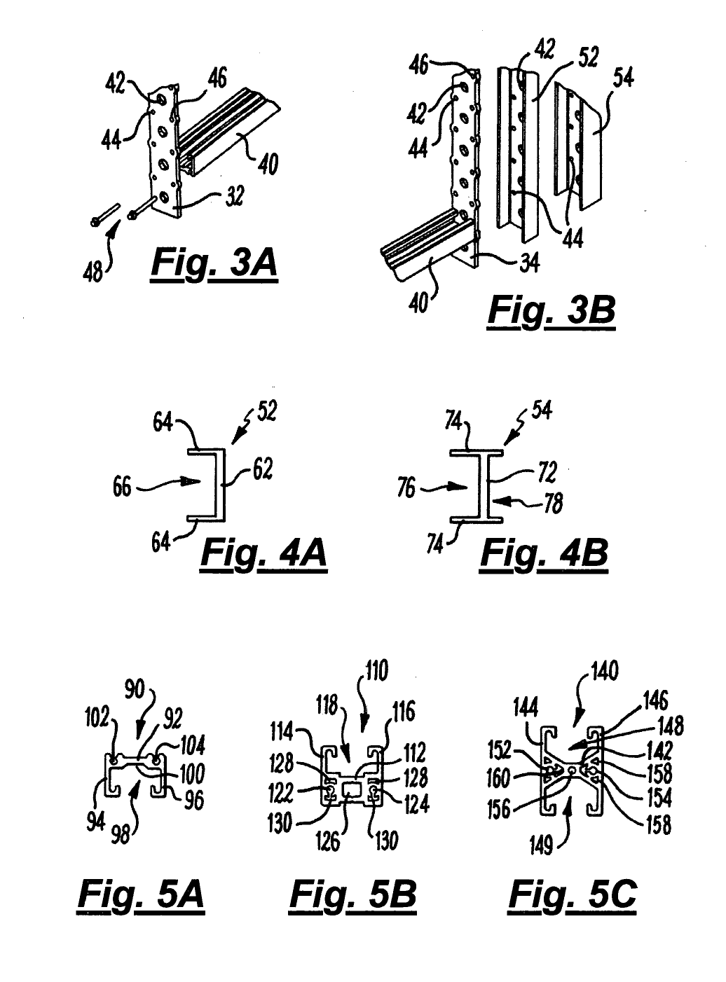

As can be seen from FIG. 2A, each of the first to third cross members 36, 38, 40 is connected to the first and second elongate arrangements 32, 34 by way of two pairs of screws 48. Considering the first cross member 36 first, a first one of the two end faces of the first cross member is presented to a face of the first elongate arrangement 32 such that two spaced apart recesses defined in the end face of the first cross member are in registration with a pair of second and third apertures 44, 46 defined in the first elongate arrangement 32. The form of the cross member, including the two recesses, is described below in more detail with reference to FIGS. 5A to 5C. Then one of a first pair of screws 48 is inserted through the second aperture 44 in the first elongate arrangement 32 and driven into the corresponding recess in the end face of the cross member 36. Another of the first pair of screws 48 is inserted through the third aperture 46 of the first elongate arrangement 32 and driven into the corresponding recess in the end face of the cross member 36. Connection of a cross member to first and second elongate arrangements 32, 34 is shown in more detail in FIGS. 3A and 3B. The cross member 36 is thus firmly connected to the first elongate arrangement 32. Thereafter a second opposite end face of the first cross member 36 is presented to a face of the second elongate arrangement 34 such that two spaced apart recesses defined in the second end face of the first cross member are in registration with a pair of second and third apertures 44, 46 defined in the second elongate arrangement 34. Another pair of screws 48 is used to firmly connect the first cross member 36 and the second elongate arrangement 34 to each other as described above with reference to the first elongate arrangement 32. The present procedure is repeated in respect of the second and third cross members 38, 40 at different locations along the first and second elongate arrangements 32, 34 to thereby form supports for three cable trays which are supported one above the other.

FIGS. 2A and 2B show a first alternative form of elongate arrangement 52 and a second alternative form of elongate arrangement 54. The first alternative form of elongate arrangement 52 comprises a first elongate planar member which is configured in respect of defining of plural first, second and third apertures as is described above with reference to the first and second elongate arrangements 32, 34. The first alternative form of elongate arrangement 52 further comprises two second elongate planar members which extend from respective opposite sides of the first elongate planar member in a direction orthogonal to the plane defined by the first elongate planar member. The two second elongate planar members extend away from one only of the two oppositely directed faces of the first elongate planar member to thereby define a channel. The first alternative form of elongate arrangement 52 is brought into use by receiving an end of a cross member in the channel. Otherwise the function of the first alternative form of elongate arrangement 52 is as described above with reference to the first and second elongate arrangements 32, 34. The second alternative form of elongate arrangement 54 has the same form as the first alternative form of elongate arrangement 52 except that the two second elongate planar members extend away from both of the two oppositely directed faces of the first elongate planar member to thereby define two oppositely directed channels. The second alternative form of elongate arrangement 54 is brought into use by receiving an end of a cross member in one of the two channels. Otherwise the function of the second alternative form of elongate arrangement 54 is as described above with reference to the first and second elongate arrangements 32, 34. The first alternative form of elongate arrangement 52 provides for greater longitudinal rigidity than the first and second elongate arrangements 32, 34 and the second alternative form of elongate arrangement 54 provides for greater longitudinal rigidity than the first alternative form of elongate arrangement 52. The first and second alternative forms of elongate arrangement 52, 54 can be used selectively to provide for greater rigidity depending on circumstances such as when the utility support apparatus is to be used in an offshore environment where it is likely to be subject to greater lateral forces than in a land based environment.

Cross sections through the first and second alternative forms of elongate arrangement are shown in FIGS. 4A and 4B. As described above with reference to FIGS. 2A and 2B, the first alternative form of elongate arrangement 52 comprises a first elongate planar member 62 and two second elongate planar members 64 which extend from respective opposite sides of the first elongate planar member 62 in a direction orthogonal to the plane defined by the first elongate planar member. The two second elongate planar members extend away from one only of the two oppositely directed faces of the first elongate planar member to thereby define a channel 66. The first alternative form of elongate arrangement 52 is 49 mm wide and 26 mm deep. As described above with reference to FIGS. 2A and 2B, the second alternative form of elongate arrangement 54 comprises a first elongate planar member 72 and two second elongate planar members 74 which extend from respective opposite sides of the first elongate planar member 72 away from both of the two oppositely directed faces of the first elongate planar member 72 to thereby define first and second oppositely directed channels 76, 78. The second alternative form of elongate arrangement 54 is 49 mm wide and 36 mm deep.

Cross sections through three alternative forms of cross member are shown in FIGS. 5A, 5B and 5C. The first form of cross member 90 shown in FIG. 5A comprises a base member 92, a first arm 94 and a second arm 96. The first arm 94 extends from a first side of the base member 92 and the second arm 96 extends from a second, opposite side of the base member 92 whereby the base member 92 and the first and second arms 94, 96 define a channel 98. The first and second arms 94, 96 are of the same form and dimensions albeit mirror images of each other. The surface of the base member 92 that defines the channel 98 defines a recessed profile 100 whereby a bolt or screw that passes through the base member from the channel may be counter-sunk. The base member 92 defines first and second recesses 102, 104 which are defined in each end face of the cross member 90 and which extend from one end face to the other end face of the cross member 90. Each recess 102, 104 has the form of an open sided bore with the opening being oriented away from the channel 98. As described above with reference to FIGS. 2A and 2B, each of the first and second recesses 102, 104 is configured to receive a bolt or screw when the cross member 90 is being attached to an elongate arrangement 32, 34. The first form of cross member 90 is 42 mm wide and 30 mm deep.

The second form of cross member 110 shown in FIG. 5B comprises a base member 112, a first arm 114 and a second arm 116. The first arm 114 extends from a first side of the base member 112 and the second arm 116 extends from a second, opposite side of the base member 112 whereby the base member 112 and the first and second arms 114, 116 define a channel 118. The first and second arms 114, 116 are of the same form and dimensions albeit mirror images of each other. As described above with reference to FIG. 5A, the base member 112 of the second form of cross member 110 defines a recess for counter-sinking of a bolt or screw that passes through the base member from the channel 118. The base member 112 defines first and second recesses 122, 124 which are defined in each end face of the cross member 110 and which extend from one end face to the other end face of the cross member 110. As described above with reference to FIGS. 2A and 2B, each of the first and second recesses 122, 124 is configured to receive a bolt or screw when the cross member 110 is being attached to an elongate arrangement 32, 34. The base member 112 further defines a first bore 126 of generally rectangular cross section which extends between opposite ends of the cross member 110. A longitudinal axis of the first bore 126 substantially coincides with a longitudinal axis of the base member 112 whereby the first bore 126 is present beneath the base of the channel 118. The relatively thin section of base member 112 between the channel 118 and the first bore provides for ease of driving of a screw from the channel 118 through the base member 112 above the first bore 126. The base member 112 yet further defines two second bores 128 which extend between opposite ends of the cross member 110. Each second bore 128 is defined by two parallel short sides, one straight long side and one curved side. Each second bore 128 is present beneath a respective one of the first and second arms 114, 116. The second bores provide for saving on material used to form the cross member 110 without undue compromise on structural integrity. The base member 112 also defines two third bores 130 which extend between opposite ends of the cross member 110. Each of the two third bores 130 is of generally the same shape as the second bore 128. Each third bore 130 is present on the opposite side of a respective one of the first and second spaced apart recesses 122, 124 to the channel 118. In addition each third bore 130 is joined to a recess 122, 124 by way of a narrow passage. This configuration provides room for part of the material of the base member 112 that defines a recess to move into the space of the third bore 130 when a screw is being driven into the recess to thereby expand the recess and provide for improved ease of driving of the screw into the recess. The second form of cross member 110 is 42 mm wide and 42 mm deep.

The third form of cross member 140 shown in FIG. 5C comprises a base member 142, a first arm 144 and a second arm 146. The first arm 144 extends from a first side of the base member 142 and the second arm 146 extends from a second, opposite side of the base member 142 away from both of the two oppositely directed faces of the base member to thereby define first and second oppositely directed channels 148, 149. The first and second arms 144, 146 are of the same form and dimensions albeit mirror images of each other. The base member 142 defines first and second recesses 152, 154 which are defined in each end face of the cross member 140 and which extend from one end face to the other end face of the cross member 140. As described above with reference to FIGS. 2A and 2B, each of the first and second recesses 152, 154 is configured to receive a bolt or screw when the cross member 140 is being attached to an elongate arrangement 32, 34. The third form of cross member 140 is 42 mm wide and 61.3 mm deep. The base member 142 further defines a first bore 156 of generally circular cross section which extends between opposite ends of the cross member 140. A longitudinal axis of the first bore 156 substantially coincides with a longitudinal axis of the base member 142 whereby the first bore 156 is present beneath the base of the channels 148, 149. The relatively thin section of base member 142 between each channel 148, 149 and the first bore provides for ease of driving of a screw from a channel 148, 149 through the base member 142 above the first bore 156. The base member 142 yet further defines two pairs of second bores 158 which extend between opposite ends of the cross member 140. Each second bore 158 is generally triangular in cross-section. Each second bore 158 is present beneath a respective one of the two branches of the first and second arms 144, 146. The second bores provide for saving on material used to form the cross member 140 without undue compromise on structural integrity. The base member 142 also defines two third bores 160 which extend between opposite ends of the cross member 140. Each of the two third bores 160 is of generally triangular cross-section. Each third bore 160 is present between a respective recess 152, 154 and the first bore 156. In addition each third bore 160 is joined to a recess 152, 154 by way of a narrow passage. As described above with reference to FIG. 5B this configuration provides room for a recess to expand to thereby provide for improved ease of driving of a screw into the recess.

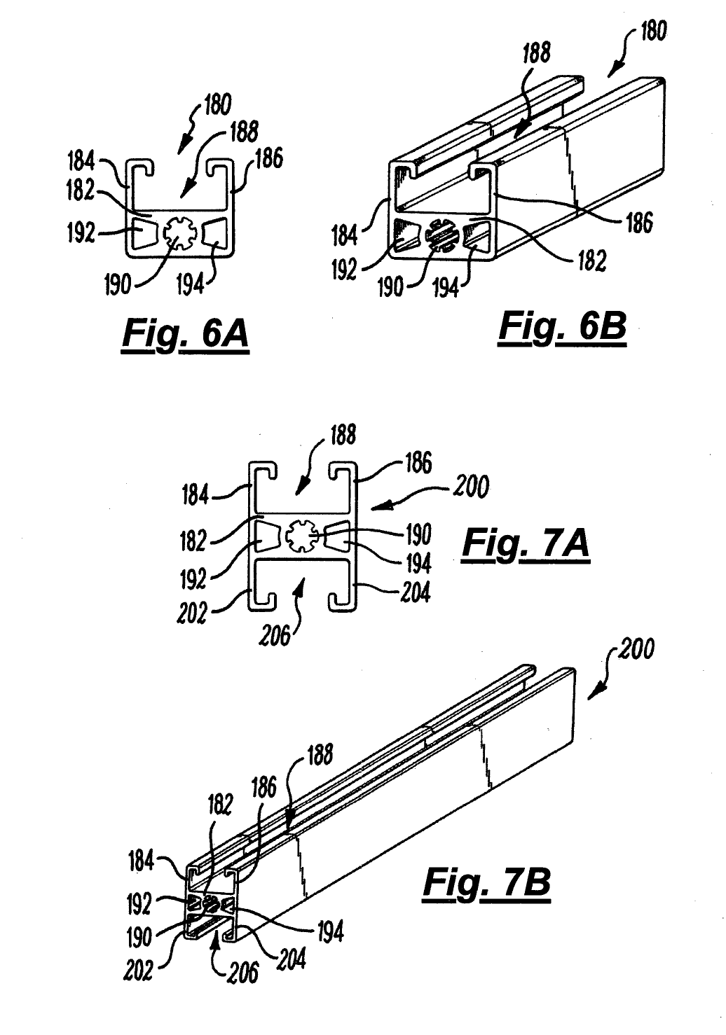

A cross section through a further embodiment of cross member 180 is shown in FIG. 6A and a perspective view of the further embodiment of cross member 180 is shown in FIG. 6B.

The cross member 180 of FIGS. 6A and 6B comprises a base member 182, a first arm 184 and a second arm 186. The first arm 184 extends from a first side of the base member 182 and the second arm 186 extends from a second, opposite side of the base member 182 whereby the base member 182 and the first and second arms 184, 186 define a channel 188. The first and second arms 184, 186 are of the same form and dimensions albeit mirror images of each other. The base member 182 defines a bore 190 which is located substantially centrally in the base member and which is a through bore such that it extends from one end of the cross member 180 to the other end of the cross member 180. The surface of the base member that defines the bore 190 defines a plurality of ridges which extend into the bore. The ridges are spaced apart substantially evenly around the bore. The base member 182 also defines first and second further bores 192, 194 of non-circular cross section which extend from one end face to the other end face of the cross member 180. The first and second further bores 192, 194 provide for saving on material used to form the cross member 180 without undue compromise on structural integrity. The longitudinal axes of the bore 190 and the first and second further bores 192, 194 are parallel to one another and to a longitudinal axis of the base member 182. The first and second further bores 192, 194 are formed in the base member 182 such that the fixing member receiving bore is between the first and second further bores 192, 194. The cross member 180 of FIGS. 6A and 6B is 42 mm wide and 38 mm deep.

The cross member 180 of FIGS. 6A and 6B is used to form the utility support apparatus 10 of FIG. 1 as follows. Elongate arrangements 54 according to FIG. 3B are attached to struts as described above with reference to FIGS. 1, 2A and 2B. The cross member 180 of FIGS. 6A and 6B is then attached between pairs of elongate arrangements 54 by passing a screw through an aperture formed midway across one of the elongate arrangements. The screw is then received in the bore 190 in one end of the cross member 180 and driven into the bore such that the threaded surface of the screw bites into the ridges in the bore. The cross member 180 and the elongate arrangement 54 are thus attached firmly to each other. A further screw is then used in the same fashion to attach the opposite end of the cross member 180 to the other one of the pair of elongate arrangements 54.

A cross section through a yet further embodiment of cross member 200 is shown in FIG. 7A and a perspective view of the further embodiment of cross member 200 is shown in FIG. 7B. Components common to the embodiment of FIGS. 6A and 6B and the embodiment of FIGS. 7A and 7B are designated by like reference numerals. The reader's attention is directed to the description provided above with reference to FIGS. 6A and 6B for a description of such components in common. Components further to those of the embodiment of FIGS. 6A and 6B will now be described. The cross member 200 of FIGS. 7A and 7B comprises first and second further arms 202, 204. The first and second further arms extend from an oppositely directed face of the base member 182 to the two spaced apart arms 184, 186 and at opposite sides of the base member to thereby define a second channel 206 between the first and second further arms. Openings to the first and second channels 188, 206 are thus substantially oppositely directed. The cross member 200 of FIGS. 7A and 7B is 42 mm wide and 58 mm deep. The cross member 200 of FIGS. 7A and 7B is brought into use in the same fashion as the cross member 180 of FIGS. 6A and 6B.

1. Utility support apparatus comprising:
first and second elongate arrangements each configured towards a proximal end to be attached to a structure so as to depend from the structure; and
a holding arrangement configured to, in use, hold utility distribution elements,
the first and second elongate arrangements being mechanically coupled to the holding arrangement at spaced apart locations on the holding arrangement, each of the first and second elongate arrangements being mechanically coupled to the holding arrangement at a location on the elongate arrangement spaced apart from the proximal end, in which
each of the first and second elongate arrangements comprises a first aperture towards the proximal end to provide for attachment to the structure and second and third apertures spaced apart from the proximal end, the second and third apertures providing for mechanical coupling to the holding arrangement and the first, second and third apertures lying in the same plane.

2. Utility support apparatus according to claim 1 in which the second and third apertures lie on a line which extends substantially orthogonally to a longitudinal axis of the elongate arrangement.

3. Utility support apparatus according to claim 1 in which centres of the second and third apertures are substantially equally spaced from a longitudinal axis of the elongate arrangement.

4. Utility support apparatus according to claim 1 in which the first aperture lies on a longitudinal axis of the elongate arrangement.

5. Utility support apparatus according to claim 1 in which each of the first and second elongate arrangements comprises plural pairs of second and third apertures, the pairs of second and third apertures being spaced apart substantially equally along the elongate arrangement.

6. Utility support apparatus according to claim 1 in which each of the first and second elongate arrangements comprises plural first apertures, the first apertures being spaced apart substantially equally along the elongate arrangement.

7. Utility support apparatus according to claim 1 in which components of the utility support apparatus are configured for releasable connection whereby the utility support apparatus is modular utility support apparatus.

8. Utility support apparatus according to claim 1 in which components of the utility support apparatus are configured for connection in each of plural different ways to form differently configured utility support apparatus.

9. Utility support apparatus according to claim 1 in which at least one of the first and second elongate arrangements comprises an elongate planar member which defines the first to third apertures.

10. Utility support apparatus according to claim 9 in which the elongate arrangement consists essentially of the elongate planar member.

11. Utility support apparatus according to claim 10 in which the elongate arrangement comprises the elongate planar member and at least one further elongate planar member, the elongate planar member and the further elongate planar member extending in substantially orthogonal planes.

12. Utility support apparatus according to claim 11 in which the elongate arrangement comprises the elongate planar member and two further elongate planar members, the two further elongate planar members extending from opposite sides of the elongate planar member.

13. Utility support apparatus according to claim 1 comprising plural pairs of first and second elongate arrangements, the pairs of first and second elongate arrangements being mechanically coupled to the holding arrangement at spaced apart locations along the holding arrangement.

14. Utility support apparatus according to claim 1 in which the holding arrangement comprises a cable tray.

15. Utility support apparatus according to claim 1 further comprising at least one cross member disposed such that it supports the holding arrangement.

16. Utility support apparatus according to claim 15 in which each of the first and second elongate arrangements is attached to the cross member at spaced apart locations on the cross member.

17. Utility support apparatus according to claim 15 in which the cross member defines two recesses spaced apart across each of two end faces of the cross member, each recess being configured to receive a fixing member which is received through a respective one of the second and third apertures.

18. Utility support apparatus according to claim 15 comprising plural pairs of first and second elongate arrangements and plural cross members spaced apart along the holding arrangement, each of the plural cross members being attached to a different pair of first and second elongate arrangements.

19. Utility support apparatus according to claim 15 in which the cross member comprises a base member and two spaced apart arms which extend from the base member to define a channel therebetween.

20. Utility support apparatus according to claim 19 in which the cross member comprises two further spaced apart arms extending from an oppositely directed face of the base member to the two spaced apart arms to thereby define a second channel between the two further spaced apart arms.

21. Utility support apparatus according to claim 19 in which the base member defines at least one bore, the bore extend from one end of the cross member to the other end of the cross member along its length.

22. (canceled)

23. (canceled)

24. (canceled)

25. (canceled)

26. (canceled)

27. A structure configured to form part of a construction, the structure comprising utility support apparatus according to claim 1.

28. (canceled)

29. (canceled)
